(19) United States
(12) Patent Application Publication
(10) Pub. No.: US 2023/0182981 A1
(43) Pub. Date: Jun. 15, 2023

(54) CORRUGATED CARDBOARD, CORRUGATED BOX, AND METHOD FOR PACKAGING A WET PRODUCT

(71) Applicant: WestRock Shared Services, LLC, Atlanta, GA (US)

(72) Inventors: William T. McDonnell, Elmhurst, IL (US); Christopher C. Jameson, Richmond, VA (US); David Brundage, Salinas, CA (US)

(73) Assignee: WestRock Shared Services, LLC, Atlanta, GA (US)

(21) Appl. No.: 18/061,540

(22) Filed: Dec. 5, 2022

Related U.S. Application Data
(60) Provisional application No. 63/289,734, filed on Dec. 15, 2021.

(51) Int. Cl. B65D 65/40; D21H 27/34; D21H 27/38; D21H 27/10; D21H 21/20; D21H 17/20; D21H 11/04; D21F 11/12; B32B 29/06; B32B 29/00; B32B 29/08; B65B 5/04; B32B 37/18; B32B 38/00

(52) U.S. Cl. CPC B65D 65/403; B32B 29/005; B32B 29/06; B32B 29/08; B32B 37/18; B32B 38/0004; B65B 5/04; D21F 11/12; D21H 11/04; D21H 17/20; D21H 21/20; D21H 27/10; D21H 27/34; D21H 27/38; B32B 2250/03; B32B 2250/26; B32B 2250/40; B32B 2307/718; B32B 2307/732; B32B 2307/5825; B32B 2307/7265; B32B 2317/127; B32B 2553/00

(57) ABSTRACT

A corrugated cardboard includes a first cellulosic fibered linerboard layer treated with a wet strength agent, a second cellulosic fibered linerboard layer, and a non-wicking corrugating medium attached to and disposed between the first cellulosic fibered linerboard layer and the second cellulosic fibered linerboard layer.

### PRIORITY

This application claims priority from U.S. Ser. No. 63/289,734 filed on Dec. 15, 2021, the entire contents of which are incorporated herein by reference.

### FIELD

The present application relates to the field of corrugated cardboard and corrugated boxes, in particularly for the packaging of celery and like products.

### BACKGROUND

Corrugated cardboard boxes are commonly employed for the packaging of goods. Typically, corrugated cardboard boxes are designed to have good strength properties when dry. In the dry condition, cellulose fibers are mainly held together by hydrogen bonds. These hydrogen bonds can be broken by wetting of the cellulose fibers. Thus, when wet, typical corrugated cardboard boxes lose strength properties and can be easily torn. Wet tear strength is typically less than 10% of its dry tear strength.

For applications in which exposure of corrugated cardboard boxes to water is expected, one common approach to mitigating this problem is to coat or impregnate the corrugated cardboard boxes with a moisture resistance agent, such as a petroleum based wax or a bio-based wax, to minimize water absorption and, thus, minimize the loss of strength. However, the service conditions for these moisture resistant corrugated cardboard boxes are similar to the conditions encountered in repulping. Therefore, while the moisture resistance agents help the corrugated cardboard boxes to resist strength decrease in the presence of water during service, the moisture resistance agents also impede the OCC (old corrugated cardboard) recyclability of the corrugated cardboard boxes during repulping.

Accordingly, those skilled in the art continue with research and development in the field of corrugated cardboard and corrugated boxes.

### SUMMARY

In one embodiment, a corrugated cardboard includes a first cellulosic fibered linerboard layer treated with a wet strength agent, a second cellulosic fibered linerboard layer, and a non-wicking corrugating medium attached to and disposed between the first cellulosic fibered linerboard layer and the second cellulosic fibered linerboard layer.

In another embodiment, a corrugated box includes a corrugated cardboard, which includes a first cellulosic fibered linerboard layer treated with a wet strength agent, a second cellulosic fibered linerboard layer, and a non-wicking corrugating medium attached to and disposed between the first cellulosic fibered linerboard layer and the second cellulosic fibered linerboard layer.

A method for packaging a wet product includes packaging a first corrugated box that includes a corrugated cardboard, which includes a first cellulosic fibered linerboard layer treated with a wet strength agent, a second cellulosic fibered linerboard layer, and a non-wicking corrugating medium attached to and disposed between the first cellulosic fibered linerboard layer and the second cellulosic fibered linerboard layer, and closing the first corrugated box.

A method for manufacturing a corrugated cardboard includes providing a first cellulosic fibered linerboard layer treated with a wet strength agent, providing a second cellulosic fibered linerboard layer, providing a non-wicking corrugating medium attached to and disposed between the first cellulosic fibered linerboard layer and the second cellulosic fibered linerboard layer, cutting the corrugated cardboard to form a cut edge, and crushing the cut edge.

Other embodiments of the disclosed corrugated cardboard, corrugated box, and method for packaging of a wet product will become apparent from the following detailed description, the accompanying drawings and the appended claims.

### BRIEF DESCRIPTION OF THE DRAWINGS

FIG. 1 is a cross sectional view of an exemplary corrugated cardboard according to an embodiment of the present description.

FIG. 2 is a plan view of an exemplary corrugated box according to an embodiment of the present description in an unassembled condition.

FIG. 3 is a bottom perspective view of an exemplary corrugated box according to an embodiment of the present description in an assembled and closed condition.

FIG. 4 is a top perspective view of an exemplary corrugated box according to an embodiment of the present description in an assembled and closed condition.

FIG. 5 is a perspective view of an exemplary corrugated box according to an embodiment of the present description in an assembled and open condition and having a wet product therein.

FIG. 6 is a perspective of a plurality of exemplary corrugated boxes according to an embodiment of the present description in a closed and stacked condition.

FIG. 7 is a plan view of another exemplary corrugated box according to an embodiment of the present description in an unassembled condition.

### DETAILED DESCRIPTION

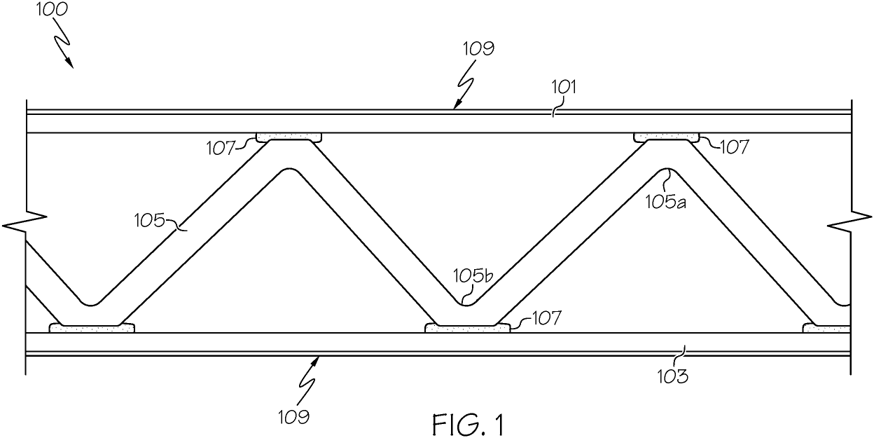

FIG. 1 illustrates a cross sectional view of an exemplary corrugated cardboard 100 according to an embodiment of the present description. Certain embodiments described herein can be used to provide a corrugated cardboard box that can be used to package a wet product (e.g., celery) without detrimental tearing while maintaining OCC recyclability.

A corrugated cardboard 100 may include a first cellulosic fibered linerboard layer 101 treated with a wet strength agent, a second cellulosic fibered linerboard layer 103, and a non-wicking corrugating medium 105 attached to and disposed between the first cellulosic fibered linerboard layer 101 and the second cellulosic fibered linerboard layer 103. The first cellulosic fibered linerboard layer 101 and second cellulosic fibered linerboard layer 103 may be attached to the non-wicking corrugating medium 105 at one or more peaks 105a, 105b of the non-wicking corrugating medium 105 using an adhesive 107. Any suitable water resistant adhesive is preferred. For example, a suitable water resistant adhesive may include or be starch.

In an aspect, the first cellulosic fibered linerboard layer may have a caliper thickness in a range of between 0.012 inches and 0.036 inches, such as between 0.014 inches and 0.032 inches, or between 0.016 inches and 0.028 inches.

In an aspect, the first cellulosic fibered linerboard layer may have a basis weight in a range of between 50 lbs/MSF (pounds per 1000 ft²) and 136 lbs/MSF, such as between 58 lbs/MSF and 120 lbs/MSF, or between 66 lbs/MSF and 106 lbs/MSF.

In an aspect, the first cellulosic fibered linerboard layer may have an Elmendorf dry tear strength of at least 300 gf, preferably at least 400 gf, more preferably at least 500 gf, more preferably at least 600 gf, more preferably at least 700 gf, and more preferably at least 800 gf.

In an aspect, the first cellulosic fibered linerboard layer may have an Elmendorf wet tear strength in a saturated condition (i.e., over 60 percent moisture content) of at least 200 gf, preferably at least 300 gf, more preferably at least 400 gf, more preferably at least 500 gf, more preferably at least 600 gf, and more preferably at least 700 gf.

The high wet tear strength of the first cellulosic fibered linerboard layer enables forming a corrugated box that is resistant to detrimental tearing, even in the saturated condition.

The high wet tear strength of the first cellulosic fibered linerboard layer may be provided by ensuring a high ratio of wet tear strength to dry tear strength. In an aspect, the first cellulosic fibered linerboard layer may have an Elmendorf wet tear strength that is at least 20% of an Elmendorf dry tear strength of the first cellulosic fibered linerboard layer. Preferably, the first cellulosic fibered linerboard layer has an Elmendorf wet tear strength that is at least 30% of an Elmendorf dry tear strength of the first cellulosic fibered linerboard layer. More preferably, the first cellulosic fibered linerboard layer has an Elmendorf wet tear strength that is at least 40% of an Elmendorf dry tear strength of the first cellulosic fibered linerboard layer. More preferably, the first cellulosic fibered linerboard layer has an Elmendorf wet tear strength that is at least 50% of an Elmendorf dry tear strength of the first cellulosic fibered linerboard layer. More preferably, the first cellulosic fibered linerboard layer has an Elmendorf wet tear strength that is at least 60% of an Elmendorf dry tear strength of the first cellulosic fibered linerboard layer. More preferably, the first cellulosic fibered linerboard layer has an Elmendorf wet tear strength that is at least 70% of an Elmendorf dry tear strength of the first cellulosic fibered linerboard layer. More preferably, the first cellulosic fibered linerboard layer has an Elmendorf wet tear strength that is at least 80% of an Elmendorf dry tear strength of the first cellulosic fibered linerboard layer. More preferably, the first cellulosic fibered linerboard layer has an Elmendorf wet tear strength that is at least 85% of an Elmendorf dry tear strength of the first cellulosic fibered linerboard layer.

The high wet tear strength of the first cellulosic fibered linerboard layer may be provided by a combination of characteristics of the first cellulosic fibered linerboard layer, such a fiber type and composition and with presence of the wet strength agent.

In an aspect, the first cellulosic fibered linerboard layer may comprise at least 50 wt% kraft fibers, preferably at least 60 wt% kraft fibers, more preferably at least 70 wt% kraft fibers, more preferably at least 80 wt% kraft fibers, and more preferably at least 85 wt% kraft fibers. The presence of a high amount of kraft fibers improves a wet tear strength of the first cellulosic fibered linerboard layer.

In an aspect, the first cellulosic fibered linerboard layer may comprise at least 50 wt% unbleached fibers, preferably at least 60 wt% unbleached fibers, more preferably at least 70 wt% unbleached fibers, more preferably at least 80 wt% unbleached fibers, and more preferably at least 85 wt% unbleached fibers. The presence of a high amount of unbleached fibers improves a wet tear strength of the first cellulosic fibered linerboard layer.

In an aspect, the first cellulosic fibered linerboard layer may comprise at least 50 wt% unbleached kraft fibers, preferably at least 60 wt% unbleached kraft fibers, more preferably at least 70 wt% unbleached kraft fibers, more preferably at least 80 wt% unbleached kraft fibers, and more preferably at least 85 wt% unbleached kraft fibers. The presence of a high amount of unbleached kraft fibers improves a wet tear strength of the first cellulosic fibered linerboard layer.

A number of different chemical treatments are used to impart temporary or permanent wet strength to paperboard. The wet strength agent may be selected from a variety of known chemical agents, such as wet strength resins, that are commonly used to manufacture high wet strength paperboard.

The high wet strength first cellulosic fibered linerboard layer is different than the prior art corrugated cardboard boxes coated or impregnated with a moisture resistance agent (e.g., waxes or biowaxes) because the wet strength agents of the present description function to retain strength properties of the paperboard layer when saturated rather than merely resisting the saturation of the paperboard with water. The first cellulosic fibered linerboard layer has high wet strength in the saturated condition (i.e., over 60 percent moisture content).

The first cellulosic fibered linerboard layer may be a high wet strength paperboard commonly utilized as a standalone paperboard packaging for beverages, in which the packaging is commonly partially or completely wetted by customers. In certain exemplary embodiments, the first cellulosic fibered linerboard layer can be CarrierKote® high-performing unbleached kraft paperboard sold by WestRock of Roanoke Rapids, North Carolina.

The first cellulosic fibered linerboard layer may include a print coating (e.g., clay coating) on an outer surface thereof to facilitate customized printing of a corrugated box formed therefrom.

In an aspect, the second cellulosic fibered linerboard layer 103 may have a basis weight in a range of between 20 lbs/MSF and 116 lbs/MSF, such as between 23 lbs/MSF and 102 lbs/MSF or between 26 lbs/MSF and 90 lbs/MSF.

In an aspect, the second cellulosic fibered linerboard layer may remain untreated with a wet strength agent. The wet tear strength of the second cellulosic fibered linerboard layer may be provided by a combination of characteristics of the second cellulosic fibered linerboard layer, such a fiber type and composition.

In an aspect, the second cellulosic fibered linerboard layer may comprise at least 50 wt% kraft fibers, preferably at least 60 wt% kraft fibers, more preferably at least 70 wt% kraft fibers, more preferably at least 80 wt% kraft fibers, and more preferably at least 85 wt% kraft fibers. The presence of a high amount of kraft fibers improves a wet tear strength of the second cellulosic fibered linerboard layer.

In an aspect, the second cellulosic fibered linerboard layer may comprise at least 50 wt% unbleached fibers, preferably at least 60 wt% unbleached fibers, more preferably at least 70 wt% unbleached fibers, more preferably at least 80 wt% unbleached fibers, and more preferably at least 85 wt% unbleached fibers. The presence of a high amount of unbleached fibers improves a wet tear strength of the second cellulosic fibered linerboard layer.

In an aspect, the second cellulosic fibered linerboard layer may comprise at least 50 wt% unbleached kraft fibers, preferably at least 60 wt% unbleached kraft fibers, more preferably at least 70 wt% unbleached kraft fibers, more preferably at least 80 wt% unbleached kraft fibers, and more preferably at least 85 wt% unbleached kraft fibers. The presence of a high amount of unbleached kraft fibers improves a wet tear strength of the second cellulosic fibered linerboard layer.

The second cellulosic fibered linerboard layer may have an Elmendorf wet tear strength that is less the Elmendorf wet tear strength of the first cellulosic fibered linerboard layer. In particular, the second cellulosic fibered linerboard layer may have an Elmendorf wet tear strength that is less than 80% of an Elmendorf dry tear strength of the second cellulosic fibered linerboard layer. In an aspect, the second cellulosic fibered linerboard layer has an Elmendorf wet tear strength that is less than 70% of an Elmendorf dry tear strength of the second cellulosic fibered linerboard layer. In another aspect, the second cellulosic fibered linerboard layer has an Elmendorf wet tear strength that is less than 60% of an Elmendorf dry tear strength of the second cellulosic fibered linerboard layer. In another aspect, the second cellulosic fibered linerboard layer has an Elmendorf wet tear strength that is less than 50% of an Elmendorf dry tear strength of the second cellulosic fibered linerboard layer. In another aspect, the second cellulosic fibered linerboard layer has an Elmendorf wet tear strength that is less than 40% of an Elmendorf dry tear strength of the second cellulosic fibered linerboard layer. In another aspect, the second cellulosic fibered linerboard layer has an Elmendorf wet tear strength that is less than 30% of an Elmendorf dry tear strength of the second cellulosic fibered linerboard layer. In another aspect, the second cellulosic fibered linerboard layer has an Elmendorf wet tear strength that is less than 20% of an Elmendorf dry tear strength of the second cellulosic fibered linerboard layer.

The second cellulosic fibered linerboard layer may be a wet strength linerboard commonly utilized as a linerboard layer for corrugated boxes subjected to extreme humidity and temperature changes during transport or storage. In certain exemplary embodiments, the first cellulosic fibered linerboard layer can be EnduraLiner™ linerboard sold by WestRock of Roanoke Rapids, North Carolina.

The non-wicking corrugating medium 105 may be non-wicking such that a 24-hour edgewick-test wick distance from an edge is less than about 36 mm, preferably less than about 18 mm, more preferably less than about 9 mm, more preferably less than about 6 mm. In certain embodiments, the first cellulosic fibered linerboard layer 101 and/or the second cellulosic fibered linerboard layer 103 can be non-wicking as well, and/or have a low Cobb value (e.g., 80 or less).

A test for edgewicking (wicking only from the edge of the material) can include laminating a sample on both sides with a waterproof medium (e.g., mylar film laminated at about 340° F.). The sample can be cut to about 1 inch by about 6 inches, or any other suitable dimensions) to form a rectangle with exposed (uncoated) edges. The sample can then be placed partially submerged in a container with water (e.g., 600 ml of water at room temperature in a 1000 ml beaker). The sample can be submerged about 2 inches below the water line for about 24 hours. After the 24 hours, the samples can be removed and measured. The test can include measuring the distance from the edge that the wicking line is shown, and/or measuring distance above the 2 inch mark if applicable.

Certain factors/components that may affect wicking performance include, for example, fiber type (e.g., Virgin pine, Virgin hardwood, and recycled fibers for improved non-wicking) recycled fiber type (OCC, DLK, newsprint, mixed paper), recycled content level, fiber refining level, fiber length, % fines, % ash content, Kappa # or lignin content, sizing chemistry and dosage level, Alkenyl Succinic Anhydride (ASA), Alum, Alkenyl ketene dimers (AKD), rosin sizing, wet end pH level, wet press load(s), porosity and porous fiber structure and uniformity, and/or single vs multi-ply paper structure.

In an aspect, the non-wicking corrugating medium may comprise at least 50 wt% kraft fibers, preferably at least 60 wt% kraft fibers, more preferably at least 70 wt% kraft fibers, more preferably at least 80 wt% kraft fibers, and more preferably at least 85 wt% kraft fibers.

In an aspect, the non-wicking corrugating medium may comprise at least 50 wt% unbleached fibers, preferably at least 60 wt% unbleached fibers, more preferably at least 70 wt% unbleached fibers, more preferably at least 80 wt% unbleached fibers, and more preferably at least 85 wt% unbleached fibers.

In an aspect, the non-wicking corrugating medium may comprise at least 50 wt% unbleached kraft fibers, preferably at least 60 wt% unbleached kraft fibers, more preferably at least 70 wt% unbleached kraft fibers, more preferably at least 80 wt% unbleached kraft fibers, and more preferably at least 85 wt% unbleached kraft fibers.

In an aspect, the non-wicking corrugating medium may have a basis weight in a range of between 18 lbs/MSF and 45 lbs/MSF.

The non-wicking corrugating medium may be, for example, a corrugated paper. As illustrated, the non-wicking corrugating medium 105 can include a fluted shape, e.g., formed using a fluting machine on liner paper or other suitable medium as appreciated by those having ordinary skill in the art.

In certain embodiments, the non-wicking corrugating medium is not impregnated and is not coated.

In certain embodiments, the non-wicking corrugating medium can be EnduraLiner™ sold by WestRock of Roanoke Rapids, North Carolina. This particular corrugating medium displays non-wicking properties. In certain embodiments, the non-wicking corrugating medium 105 of this type can have a basis weight between about 18 to about 45 pounds per square foot, which provide a desired compression characteristics. Any other suitable basis weight for any suitable application is contemplated herein. Any other suitable non-wicking material(s) are contemplated for use as the non-wicking corrugating medium 105 (e.g., materials displaying non-wicking characteristics as defined in an edgewicking test described below).

In additional aspect, the first cellulosic fibered linerboard layer 101 and/or the second cellulosic fibered linerboard layer 103 may each include a low Cobb value coating 109 on an outer surface thereof that does not prevent the corrugated cardboard 100 from being recyclable (e.g., a non-wax coating).

The low Cobb value coating 109 can have a Cobb value of less than about 60 grams per square meter or less, or about 85 grams per square meter or less, for example (e.g., about 0 to about 20 grams per square meter). The low Cobb value coating 109 can be recyclable. In certain embodiments, the first cellulosic fibered linerboard layer 101 and/or the second cellulosic fibered linerboard layer 103 can be non-wicking low Cobb layers. Cobb value can be determined using the known TAPPI 30-minute Cobb test.

The corrugated cardboard can be made by, for example, attaching the first cellulosic fibered linerboard layer 101 to the non-wicking corrugating medium 105 on a first side of the non-wicking corrugating medium 105 using a water resistant adhesive 107 (e.g., starch) and attaching the second cellulosic fibered linerboard layer 103 to the non-wicking corrugating medium 105 on the second side of the non-wicking corrugating medium 105 using a water resistant adhesive 107 to form the corrugated cardboard 100 without using wax. The method can include coating the first cellulosic fibered linerboard layer 101 and/or the second cellulosic fibered linerboard layer 103 with a low Cobb coating (e.g., waterproof starch).

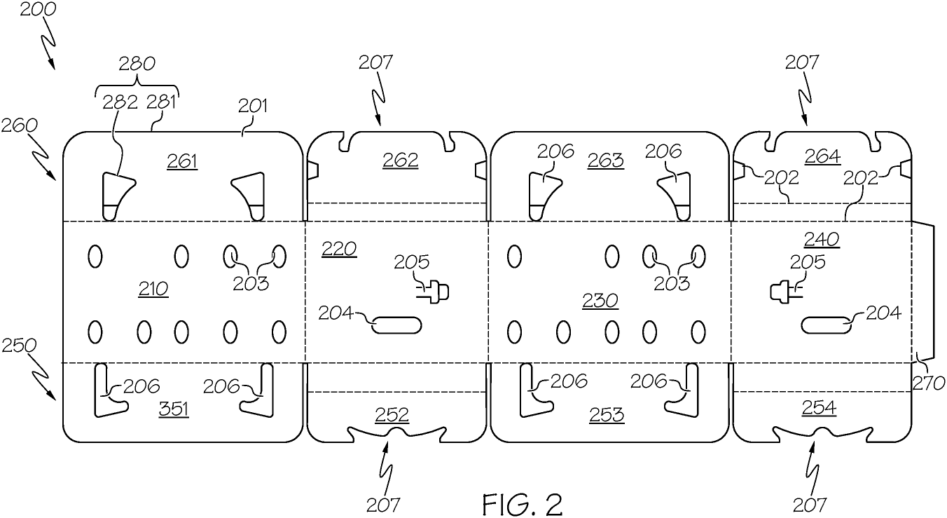

FIG. 2 illustrates an exemplary corrugated box 200 according to an embodiment of the present description in an unassembled condition. The corrugated box 200 is manufactured according to any of the aspects of the corrugated cardboard as described above. The corrugated box 200 may have a first side 201 corresponding to the first cellulosic fibered linerboard layer 101 and a second side (not shown) corresponding to the second cellulosic fibered linerboard layer 103. The corrugated box 200 include a variety of score lines 202 that facilitate a folding of the corrugated box 200. The high wet tear strength of the first cellulosic fibered linerboard layer 101 of the present description avoids or mitigates failure of the corrugated box along the score lines 202 when in a saturated condition.

Referring to FIG. 2, the exemplary corrugated box 200 may include, for example, a first panel 210, a second panel 220, a third panel 230, and a fourth panel 240. The first panel 210 may be attached (e.g., glued) to the fourth panel 240. The exemplary corrugated box 200 may include a bottom panel 250 formed from a first bottom flap 251, a second bottom flap 252, a third bottom flap 253, and a fourth bottom flap 254. The exemplary corrugated box 200 may include a top panel 260 formed from a first top flap 261, a second top flap 262, a third bottom top 263, and a top bottom flap 264. The corrugated box 200 may include an attachment flap 270 for attaching the first panel 210 to the fourth panel 240, such as by way of an adhesive. The corrugated box 200 may include additional features, such as vents 203 (e.g., circular vents, oval-shaped vents), handles 204, straps 205, locks 206, and tabs 207.

The corrugated box 200 may include one or more cut edges 280 having the non-wicking corrugating medium exposed. The one or more cut edges 280 may include one or more peripheral edges 281 of the corrugated cardboard 200 defining a periphery of the corrugated cardboard 200. The one or more peripheral edges 281 may define the peripheral features of the first panel 210, the second panel 220, the third panel 230, and/or the fourth panel 240, including, for example, the locks 206 and tabs 207. The one or more cut edges 280 may include one or more interior edges 282 of the corrugated cardboard 200 within a periphery of the corrugated cardboard 200. The one or more interior edges 282 may define the interior features of the first panel 210, the second panel 220, the third panel 230, and/or the fourth panel 240, including, for example, vents 203, handles 204, and straps 205. In the illustrated corrugated box 200 of FIG. 2, the cut edge 280 are uncrushed, i.e., in the as-cut state. However, the corrugated box 200 of FIG. 2 could include one or more crushed edges as further discussed below.

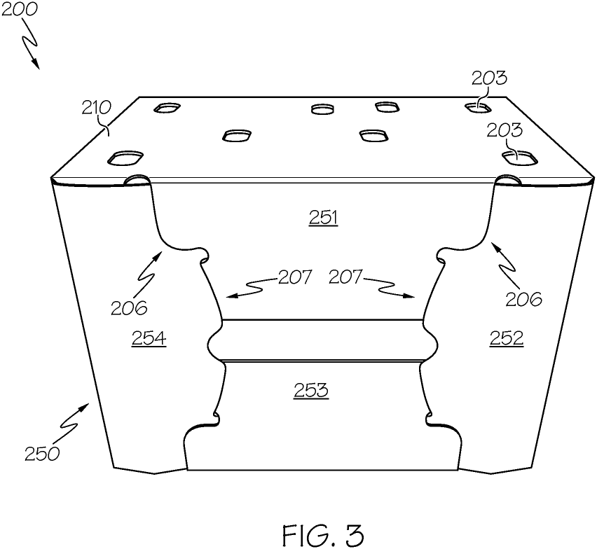

FIG. 3 is a bottom perspective view of an exemplary corrugated box 200 according to an embodiment of the present description in an assembled and closed condition. FIG. 3 illustrates the corrugated box 200 including first panel 210 including vents 203, bottom panel 250 including first bottom flap 251, second bottom flap 252, third bottom flap 253, and fourth bottom flap 254, and including locks 206 and tabs 207 for locking together the bottom flaps to form the bottom panel 250.

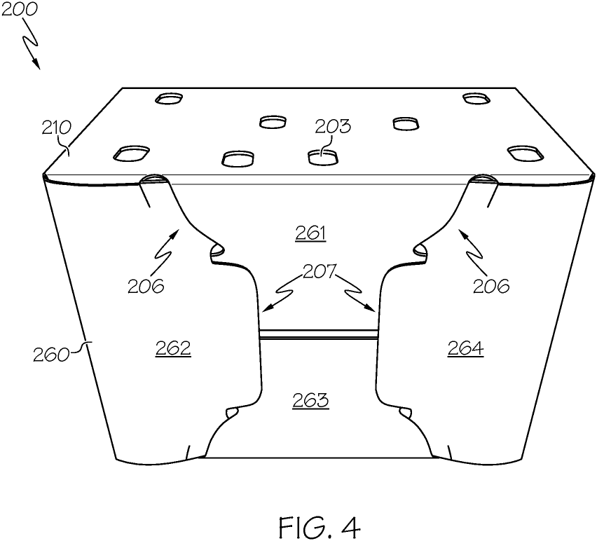

FIG. 4 is a top perspective view of an exemplary corrugated box 200 according to an embodiment of the present description in an assembled and closed condition. FIG. 4 illustrates the corrugated box 200 including first panel 210 including vents 203, top panel 260 including first top flap 261, second top flap 262, third top flap 263, and fourth top flap 264, and including locks 206 and tabs 207 for locking together the top flaps to form the top panel 260.

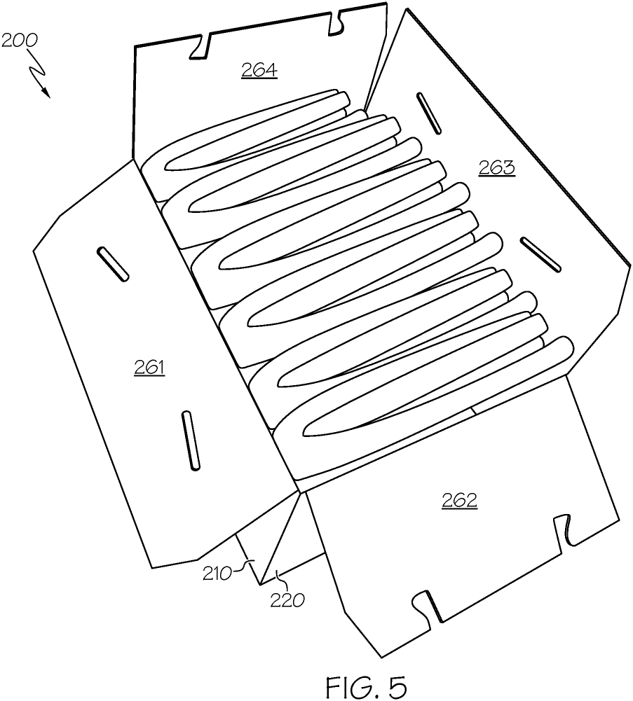

FIG. 5 is a perspective view of an exemplary corrugated box 200 according to an embodiment of the present description in an assembled and open condition and having a wet product (i.e., celery) therein. FIG. 5 illustrates the corrugated box 200 including first panel 210, second panel 220, and top panel including first top flap 261, second top flap 262, third top flap 263, and fourth top flap 264. The top panel is in an open condition to allow the wet product to be loaded therein.

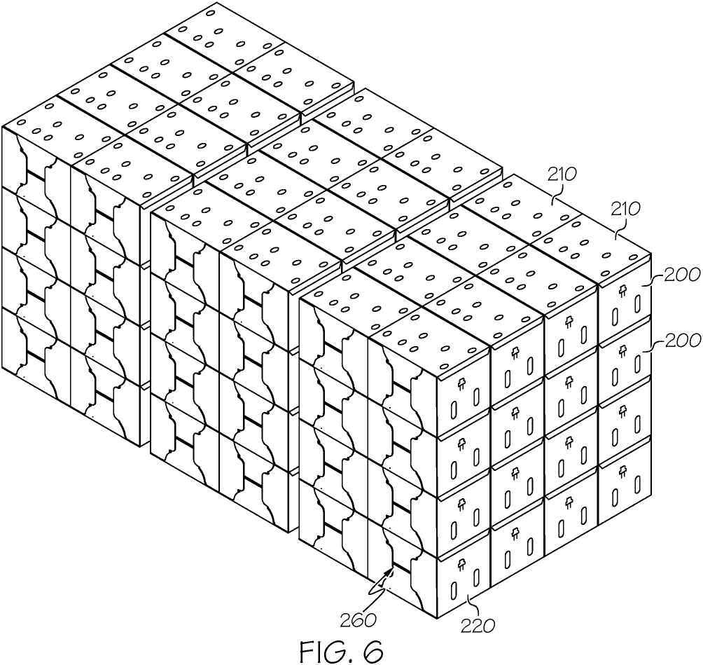

FIG. 6 is a perspective of a plurality of exemplary corrugated boxes 200 according to an embodiment of the present description in a closed and stacked condition. As illustrated in FIG. 6, the corrugated boxes 200 may be stacked in a sideway configuration such that first panel 210 and third panel 230 are upper and lower sides of the stacked corrugated boxes 200.

The present description relates to a corrugated cardboard and corrugated box for holding wet product (e.g., celery) having score lines preferably made from a high wet tear strength predominantly kraft fibered carrier outer board, a predominantly kraft fibered inside linerboard, and a non-wicking predominantly kraft fibered corrugating medium to contain celery loads and prevent tear failure along the score lines. The invention replaces conventional cascade waxed corrugated produce boxes for packaging of celery. The produce box does not include any waxes, bio-waxes, impregnations, or coatings that would impede OCC recyclability. Rather, the produce box employs materials having the necessary strength properties without such additives. The produce box of the present invention can be recycled as OCC after its use, whereas the conventional wax cascaded corrugated produce boxes cannot be recycled as OCC. The particular use of the corrugated box for packaging of celery is advantageous because the celery itself can provide resistance against compression of the carboard box when loaded corrugated box are stacked upon each other. Thus, the strength of the celery against compression facilitate the use of a non-waxed corrugated box that may become saturated and lose compression strength.

The present description also relates to a further improvement of the corrugated cardboard and corrugated box for holding wet product therein, in which one or more cut edges are crushed. The one or more crushed edges can include one or more peripheral edges of the corrugated cardboard defining a periphery of the corrugated cardboard and/or one or more interior edges of the corrugated cardboard within a periphery of the corrugated cardboard.

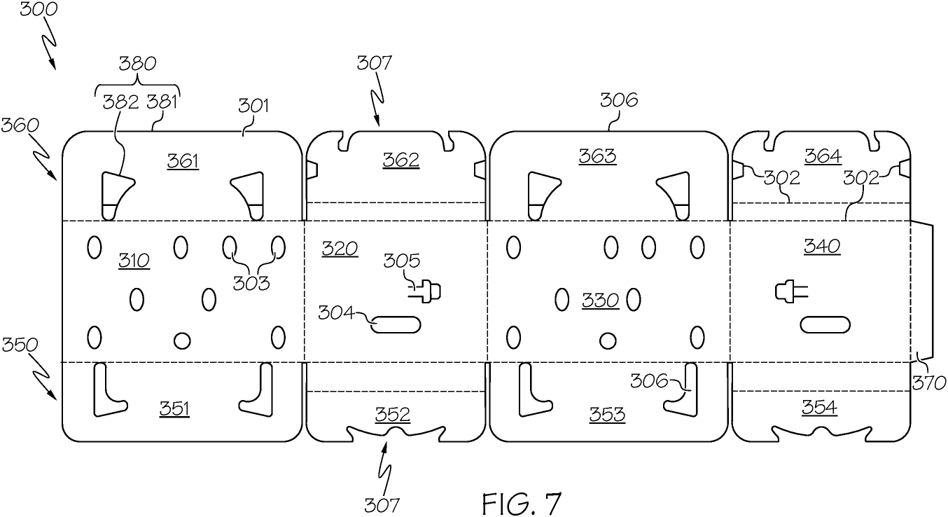

FIG. 7 illustrates an exemplary corrugated box 300 according to an embodiment of the present description in an unassembled condition. The corrugated box 300 is manufactured according to any of the aspects of the corrugated cardboard as described above. The corrugated box 300 may have a first side 301 corresponding to the first cellulosic fibered linerboard layer 101 and a second side (not shown) corresponding to the second cellulosic fibered linerboard layer 103. The corrugated box 300 include a variety of score lines 302 that facilitate a folding of the corrugated box 300. The high wet tear strength of the first cellulosic fibered linerboard layer 101 of the present description avoids or mitigates failure of the corrugated box along the score lines 302 when in a saturated condition.

Referring to FIG. 7, the exemplary corrugated box 300 may include, for example, a first panel 310, a second panel 320, a third panel 330, and a fourth panel 340. The first panel 310 may be attached (e.g., glued) to the fourth panel 340. The exemplary corrugated box 300 may include a bottom panel 350 formed from a first bottom flap 351, a second bottom flap 352, a third bottom flap 353, and a fourth bottom flap 354. The exemplary corrugated box 300 may include a top panel 360 formed from a first top flap 361, a second top flap 362, a third bottom top 363, and a top bottom flap 364. The corrugated box 300 may include an attachment flap 370 for attaching the first panel 310 to the fourth panel 340, such as by way of an adhesive. The corrugated box 300 may include additional features, such as vents 303 (e.g., circular vents, oval-shaped vents), handles 304, straps 305, locks 306, and tabs 307.

The corrugated box 300 may include one or more cut edges 380 having the non-wicking corrugating medium exposed. The one or more cut edges 380 may include one or more peripheral edges 381 of the corrugated cardboard 300 defining a periphery of the corrugated cardboard 300. The one or more peripheral edges 381 may define the peripheral features of the first panel 310, the second panel 320, the third panel 330, and/or the fourth panel 340, including, for example, the locks 306 and tabs 307. The one or more cut edges 380 may include one or more interior edges 382 of the corrugated cardboard 300 within a periphery of the corrugated cardboard 300. The one or more interior edges 382 may define the interior features of the first panel 310, the second panel 320, the third panel 330, and/or the fourth panel 340, including, for example, vents 303, handles 304, and straps 305. In the illustrated corrugated box 300 of FIG. 7, the cut edge 280 are crushed. However, the corrugated box 300 of FIG. 7 could include one or more uncrushed edges.

Referring to FIG. 1, in one aspect, for the crushed edges, the first cellulosic fibered linerboard layer 101 and second cellulosic fibered linerboard layer 103 may be pushed closer together relative to uncrushed portions of the corrugated box 300. In another aspect, portions of the non-wicking corrugating medium 105 may be bent to accommodate the crushing together of the first cellulosic fibered linerboard layer 101 and second cellulosic fibered linerboard layer 103. In another aspect, portions of the non-wicking corrugating medium 105 may be broken to accommodate the crushing together of the first cellulosic fibered linerboard layer 101 and second cellulosic fibered linerboard layer 103. In another aspect, portions of the non-wicking corrugating medium 105 may be detached from one or both of the first cellulosic fibered linerboard layer 101 and second cellulosic fibered linerboard layer 103 to accommodate the crushing together of the first cellulosic fibered linerboard layer 101 and second cellulosic fibered linerboard layer 103. By crushing one or more cut edges 380 of the corrugated box 300, moisture penetration into the exposed non-wicking corrugating medium 105 at the cut edges 280 is reduced.

The crushing of the one or more cut edges 380 may be performed by any suitable manner for crushing the edges, including peripheral edges of the corrugated box 300 and interior edges of the corrugated box 300. A material (or combination of materials) having a suitable hardness may be used for crushing the edges. As one example, wood may be used to perform the crushing. As another example, rubber may be used to perform the crushing. As yet another example, both wood and rubber may be used to perform the crushing. The material may be configured in various ways to perform the crushing of the edges. In one example, the crushing material may be a strip of material (e.g., a strip of wood and/or rubber). In another example, the crushing material may be configured as a roller (e.g., a wooden roller and/or a rubber roller) or like tool.

Although various embodiments of the disclosed corrugated cardboard, corrugated box, and method for packaging of a wet product have been shown and described, modifications may occur to those skilled in the art upon reading the specification. The present application includes such modifications and is limited only by the scope of the claims.

1. A corrugated cardboard, comprising:
a first cellulosic fibered linerboard layer treated with a wet strength agent;
a second cellulosic fibered linerboard layer; and
a non-wicking corrugating medium attached to and disposed between the first cellulosic fibered linerboard layer and the second cellulosic fibered linerboard layer.

2. The corrugated cardboard of claim 1 wherein the first cellulosic fibered linerboard layer has a caliper thickness in a range of between 0.012 inches and 0.036 inches.

3-7. (canceled)

8. The corrugated cardboard of claim 1 wherein the first cellulosic fibered linerboard layer has an Elmendorf dry tear strength of at least 300 gf.

9-13. (canceled)

14. The corrugated cardboard of claim 1 wherein the first cellulosic fibered linerboard layer has an Elmendorf wet tear strength of at least 200 gf.

15-19. (canceled)

20. The corrugated cardboard of claim 1 wherein the first cellulosic fibered linerboard layer has an Elmendorf wet tear strength that is at least 20% of an Elmendorf dry tear strength of the first cellulosic fibered linerboard layer.

21-42. (canceled)

43. The corrugated cardboard of claim 1 wherein the wet strength agent comprises a wet strength resin.

44-61. (canceled)

62. The corrugated cardboard of claim 1 wherein the second cellulosic fibered linerboard layer is untreated with a wet strength agent.

63. The corrugated cardboard of claim 1 wherein the second cellulosic fibered linerboard layer has an Elmendorf wet tear strength that is less than 80% of an Elmendorf dry tear strength of the second cellulosic fibered linerboard layer.

64-69. (canceled)

70. The corrugated cardboard of claim 1 wherein the non-wicking corrugating medium is non-wicking such that a 24-hour edgewick-test wick distance from an edge is less than about 36 mm.

71-72. (canceled)

73. The corrugated cardboard of claim 1 wherein the non-wicking corrugating medium is non-wicking such that a 24-hour edgewick-test wick distance from an edge is less than about 6 mm.

74. The corrugated cardboard of claim 1 wherein the non-wicking corrugating medium has a basis weight in a range of between 18 lbs/MSF and 45 lbs/MSF.

75. The corrugated cardboard of claim 1 wherein the non-wicking corrugating medium is corrugated paper.

76. The corrugated cardboard of claim 1 wherein the non-wicking corrugating medium comprises at least 50 wt% kraft fibers.

77-80. (canceled)

81. The corrugated cardboard of claim 1 wherein the non-wicking corrugating medium comprises at least 50 wt% unbleached fibers.

82-85. (canceled)

86. The corrugated cardboard of claim 1 wherein the non-wicking corrugating medium comprises at least 50 wt% unbleached kraft fibers.

87-90. (canceled)

91. The corrugated cardboard of claim 1 wherein the first cellulosic fibered linerboard layer and the second cellulosic fibered linerboard layer are attached to the non-wicking corrugating medium at one or more peaks of the non-wicking corrugating medium using an adhesive.

92. The corrugated cardboard of claim 1, wherein the corrugated cardboard comprises one or more cut edges having the non-wicking corrugating medium exposed.

93-95. (canceled)

96. The corrugated cardboard of claim 92 wherein at least one of the one or more cut edges are crushed.

97. (canceled)

98. A method for packaging a wet product, comprising:
packaging a first corrugated box comprising the corrugated cardboard of claim 1 with a first wet product; and
closing the first corrugated box.

99-101. (canceled)

102. A method for manufacturing a corrugated cardboard, the method comprising:
providing a first cellulosic fibered linerboard layer treated with a wet strength agent;
providing a second cellulosic fibered linerboard layer;
providing a non-wicking corrugating medium attached to and disposed between the first cellulosic fibered linerboard layer and the second cellulosic fibered linerboard layer;
cutting the corrugated cardboard to form a cut edge; and
crushing the cut edge.

103-104. (canceled)
